(19) United States
(12) Patent Application Publication
(10) Pub. No.: US 2008/0159145 A1
(43) Pub. Date: Jul. 3, 2008

(54) Weighted bandwidth switching device

(76) Inventors: Raman Muthukrishnan, San Jose, CA (US); Anujan Varma, Cupertino, CA (US)

Correspondence Address: RYDER IP LAW;C/O INTELLEVATE, LLC, P. O. BOX 52050, MINNEAPOLIS, MN, 55402, US

(21) Appl. No.: 11/647,997

(22) Filed: Dec. 29, 2006

(51) Int. Cl. H04J 1/16

(52) U.S. Cl. 370/235; 370/412; 370/468

(57) ABSTRACT

In general, in one aspect, the disclosure describes an apparatus that includes a plurality of ingress modules to receive packets from external sources and to store the packets in queues based on flow. A plurality of egress modules transmit packets received from the plurality of ingress modules to external sources. A crossbar matrix provides configurable connectivity between the plurality of ingress modules and the plurality of egress modules. A scheduler receives requests for utilization of the crossbar matrix from at least a subset of the plurality of ingress modules, arbitrates amongst the requests, grants at least a subset of the requests, and configures the crossbar matrix based on the granted requests. The flows are assigned weights defining an amount of data to be transmitted during a period. When a flow meets or exceeds the assigned weight during the period the flow is deactivated from the schedule arbitration.

### BACKGROUND

Store-and-forward devices, such as switches and routers, are used in packet networks, such as the Internet, to direct traffic at interconnection points. The store-and-forward devices include line cards to receive (ingress ports) and transmit (egress ports) packets from/to external sources. The line cards are connected to a switching fabric via a backplane. The switching fabric provides configurable connections between the line cards. The packets received at the ingress ports are stored in queues prior to being transmitted to the appropriate egress ports. The queues are organized by egress port and may also be organized by priority.

The store-and-forward devices also include a scheduler to schedule transmission of packets from the ingress ports to the egress ports via the switch fabric. The ingress ports send requests to the scheduler for the queues having packets stored therein. The scheduler considers the source and destination and possibly priority when issuing grants. The scheduler issues grants for queues from multiple ingress ports each cycle. The ingress ports transfer packets from the selected queues to the corresponding ingress ports in parallel across the crossbar switching matrix.

Transmitting packets of variable size through the switch fabric during the same cycle results in wasted bandwidth. For example, when a 50-byte packet and a 1500-byte are transmitted in the same cycle the switch fabric must be maintained in the same configuration for the duration of the 1500-byte packet. Only 1/30^{th} of the bandwidth of the path is used by the 50-byte packet.

Dividing the packets into fixed-size units (typically size of smallest packet) for transmission and then reassembling the packets as necessary after transmission reduces or avoids the wasted bandwidth of the switch fabric. However, the smaller fixed sized units increase the scheduling and the fabric switch reconfiguration rates. For example, a unit size of 64 bytes and a port rate of 10 Gigabits/second results in scheduling and reconfiguration rates of 51.2 nanoseconds.

### BRIEF DESCRIPTION OF THE DRAWINGS

The features and advantages of the various embodiments will become apparent from the following detailed description in which:

FIG. 1 illustrates an example store-and-forward device, according to one embodiment;

FIG. 2 illustrates an example frame based store-and-forward device, according to one embodiment;

FIG. 3 illustrates an example pipeline schedule for a store-and-forward device, according to one embodiment;

FIGS. 4A-B illustrates an example request frame, according to one embodiment;

FIG. 5 illustrates an example encoding scheme for quantizing the amount of data, according to one embodiment;

FIG. 6 illustrates an example scheduling engine, according to one embodiment;

FIGS. 7A-B illustrate example SPL mapping tables, according to one embodiment;

FIGS. 8A-B illustrates an example combined grant frame, according to one embodiment; and

FIG. 9 illustrates an example flow chart for scheduling of weighted flows, according to one embodiment.

### DETAILED DESCRIPTION

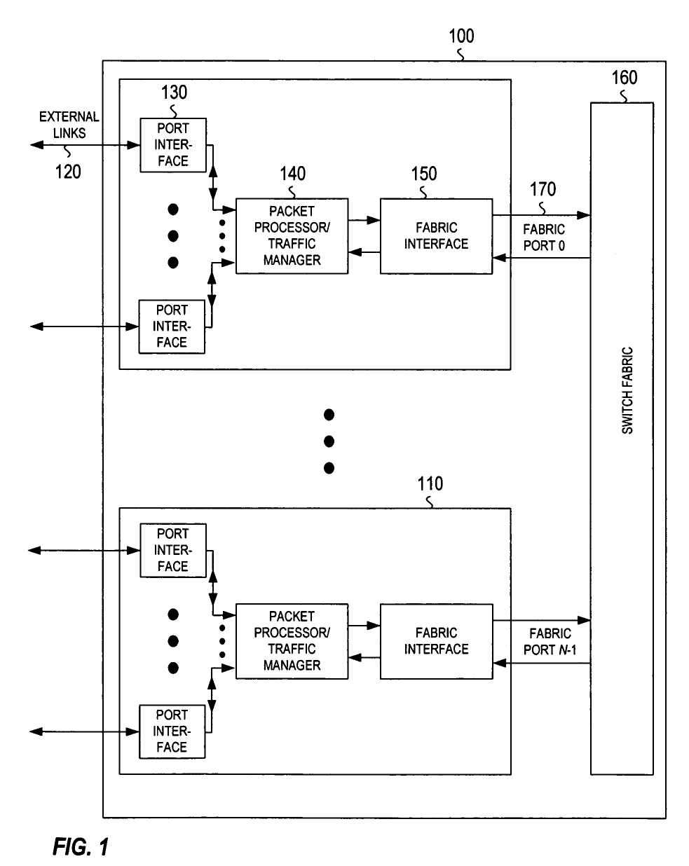

FIG. 1 illustrates an example store-and-forward device 100. The device 100 includes a plurality of line cards 110 that connect to, and receive data from and transfer data to, external links 120. The line cards include port interfaces 130, packet processor and traffic manager devices 140, and fabric interfaces 150. The port interfaces 130 provide the interface between the external links 120 and the line card 110. The port interface 130 may include a framer, a media access controller, or other components required to interface with the external links (not illustrated). The packet processor and traffic manager device 140 receives data from the port interface 130 and provides forwarding, classification, and queuing based on flow (e.g., destination, priority, class of service). The fabric interface 150 provides the interface necessary to connect the line cards 110 to a switch fabric 160. The fabric interface 150 includes an ingress port interface (from the line card 110 to the switch fabric 160) and an egress port interface (from the switch fabric 160 to the line card 110). For simplicity only a single fabric interface 150 is illustrated, however multiple fabric interfaces 150 could be contained on each line card 110.

The switch fabric 160 provides re-configurable data paths between the line cards 110 (or fabric interfaces). The switch fabric 160 includes a plurality of fabric ports 170 (addressable interfaces) for connecting to the line cards 110 (port interfaces). Each fabric port 170 is associated with a fabric interface (pair of ingress fabric interface modules and egress fabric interface modules). The switch fabric 160 can range from a simple bus-based fabric to a fabric based on crossbar (or crosspoint) switching devices. The choice of fabric depends on the design parameters and requirements of the store-and-forward device (e.g., port rate, maximum number of ports, performance requirements, reliability/availability requirements, packaging constraints). Crossbar-based fabrics may be used-for high-performance routers and switches because of their ability to provide high switching throughputs.

It should be noted that a fabric port 170 may aggregate traffic from more than one external port (link) associated with a line card. A pair of ingress and egress fabric interface modules is associated with each fabric port 170. When used herein the term fabric port may refer to an ingress fabric interface module and/or an egress fabric interface module. An ingress fabric interface module may be referred to as a source fabric port, a source port, an ingress fabric port, an ingress port, a fabric port, or an input port. Likewise an egress fabric interface module may be referred to as a destination fabric port, a destination port, an egress fabric port, an egress port, a fabric port, or an output port.

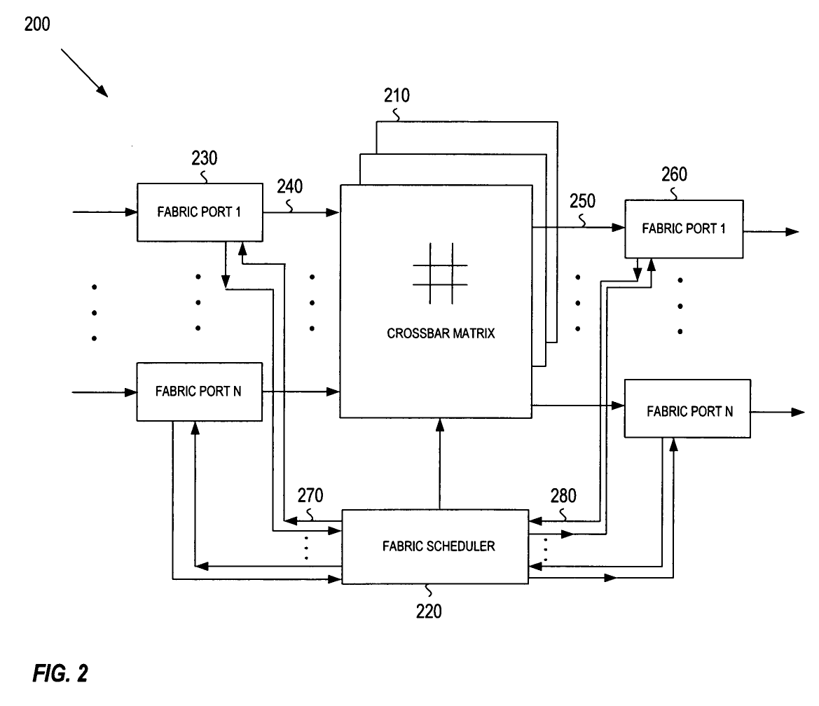

FIG. 2 illustrates an example frame based store-and-forward device 200. The device 200 introduces a data aggregation scheme wherein variable-size packets received are first segmented into smaller units (segments) and then aggregated into convenient blocks (“frames”) for switching. The device 200 includes a switching matrix 210 (made up of one or more crossbar switching planes), a fabric scheduler 220, ingress fabric interface modules 230, input data channels 240 (one or more per fabric port), output data channels 250 (one or more per fabric port), egress fabric interface modules 260, ingress scheduling channels 270 and egress scheduling channels 280. The data channels 240, 250 and the scheduling channels 270, 280 may be separate physical channels or may be the same physical channel logically separated.

The ingress fabric interface module 230 receives packets from the packet processor/traffic manager device (e.g., 140 of FIG. 1). The ingress fabric interface module 230 divides packets over a certain size into segments having a maximum size. As the packets received may have varying sizes, the number of segments generated and the size of the segments may vary. The segments may be padded so that the segments are all the same size.

The ingress fabric interface module 230 stores the segments in queues. The queues may be based on flow (e.g., destination, priority). The queues may be referred to as virtual output queues. The ingress fabric interface module 230 sends requests for permission to transmit data from its virtual output queues containing data to the scheduler 220.

Once a request is granted for a particular virtual output queue, the ingress fabric interface module 230 dequeues segments from the queue and aggregates the segments into a frame having a maximum size. The frame will consist of a whole number of segments so if the segments are not all the same size the constructed frames may not be the same size. The frames may be padded to the maximum size so that the frames are all the same size. The maximum size of the frame is a design parameter. A frame may have segments associated with different packets.

The frame is transmitted to the switching matrix 210. The switching matrix 210 routes the frame to the appropriate egress fabric interface modules 260. The time taken to transmit the maximum-size frame is referred to as the “frame period.” This interval is the same as a scheduling interval (discussed in further detail later). The frame period can be chosen independent of the maximum packet size in the system. The frame period may be chosen such that a frame can carry several maximum-size segments. The frame period may be determined by the reconfiguration time of the crossbar data path.

The egress fabric interface modules 260 receive the frames from the switching matrix 210 and splits the frame into the plurality of segments. The egress fabric interface modules 260 recreates a packet by configuring the appropriate segments together. The egress fabric interface modules 260 transmits the packets to the packet processor/traffic manager device for further processing.

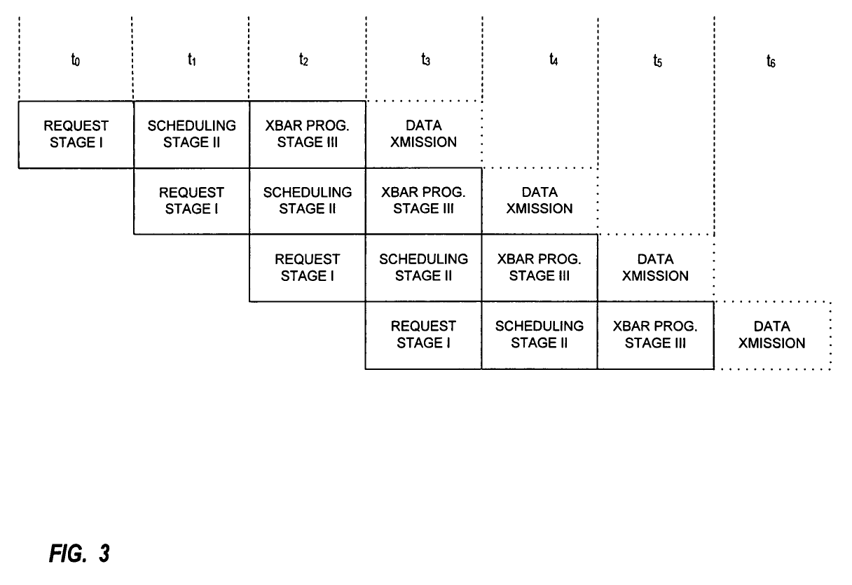

FIG. 3 illustrates an example pipeline schedule for a store-and-forward device. The pipeline schedule includes 4 stages. Stage I is the request stage. During this stage, the ingress fabric interface modules (e.g., 230) send their requests to the fabric scheduler (e.g., 220). The scheduler can perform some pre-processing of the requests in this stage while the requests are being received. Stage II is the schedule stage. During this stage, the scheduler matches the ingress modules to egress modules. At the end of this stage, the scheduler sends a grant message to the ingress fabric interface modules specifying the egress modules to which it should be sending data. The scheduler may also send the grants to the egress modules for error detection.

Stage III is the crossbar configuration stage. During this stage, the scheduler configures the crossbar planes based on the matches computed during stage II. While the crossbar is being configured, the ingress modules de-queue segments from the appropriate queues in order to form frames. The scheduler may also send grants to the egress modules for error detection during this stage. Stage IV is the data transmission stage. During this stage, the ingress modules transmit the frames across the crossbar. The time for each stage is equivalent to time necessary to transmit the frame (frame period). For example, if the frame size, including its header, is 3000 bytes and the port speed is 10 Gbs the frame period is 2.4 microseconds, (3000 bytes×8 bits/byte)/10 Gbs.

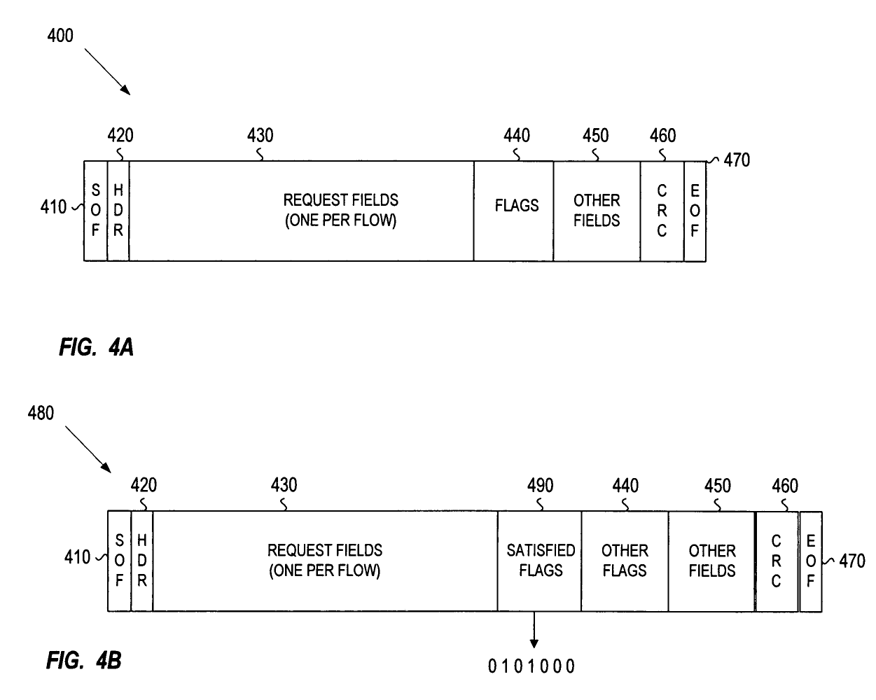

FIG. 4A illustrates an example request frame 400. The request frame 400 includes a start of frame (SOF) delimiter 410, a frame header 420, request fields (requests) 430, flags 440, other fields 450, an error detection/correction field 460, and an end of frame (EOF) delimiter 470. The other fields 450 may be used for functions such as flow control and error control. The flags 440 can be used to indicate if a certain feature is operational or if certain criteria have been met. The request fields 430 may include a request for each flow (e.g., destination fabric port and priority level). Assuming an example system with 64 fabric ports and 4 priority levels, there would be 256 (64 ports×4 priorities/port) distinct request fields 430. The request fields 430 may simply indicate if there is data available for transmission from an associated queue. The request fields 430 may identify parameters including the amount of data, the age of the data, and combinations thereof.

The amount of data in a queue may be described in terms of number of bytes, packets, segments or frames. If the data is transmitted in frames the request fields 430 may quantize the amount of data as the number of data frames it would take to transport the data within the associated queue over the crossbar planes. The length of the request fields 430 (e.g., number of bits) associated with the amount of data defines the granularity to which the amount of data can be described. For example, if the request fields 430 included 4 bits to define amount of data that would provide 16 different intervals by which to for classify the amount of data.

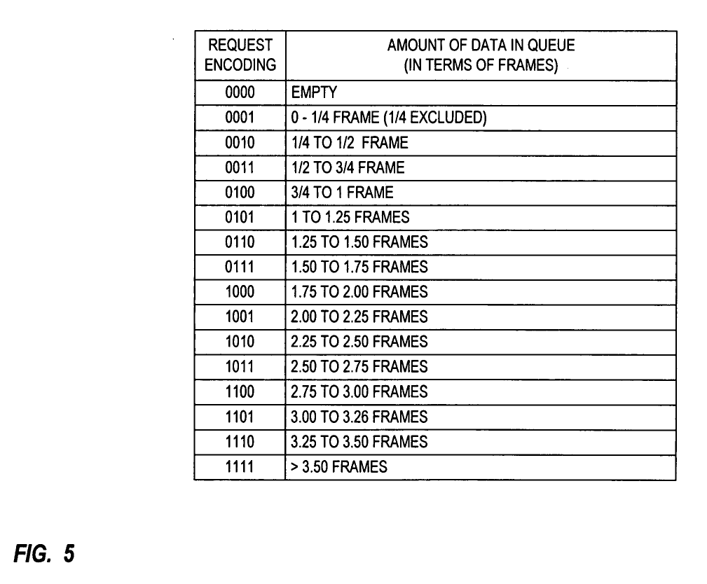

FIG. 5 illustrates an example encoding scheme for quantizing the amount of data based on frames. As illustrated, the scheme identifies the amount of data based on ¼ frames. Since we have a 3-stage scheduler pipeline (request, grant, configure), the length quantization is extended beyond 3 frames to prevent bubbles in the pipeline.

The age of data may be defined as the amount of time that data has been in the queue. This time can be determined as the number of frame periods since the queue has had a request granted. The ingress ports may maintain an age timer for each queue. The age counter for a queue may be incremented each frame period that a request is not issued for the queue. The age counter may be reset when a request is granted for the queue. The length of the request fields 530 (e.g., number of bits) associated with the data age defines the granularity to which the age can be described.

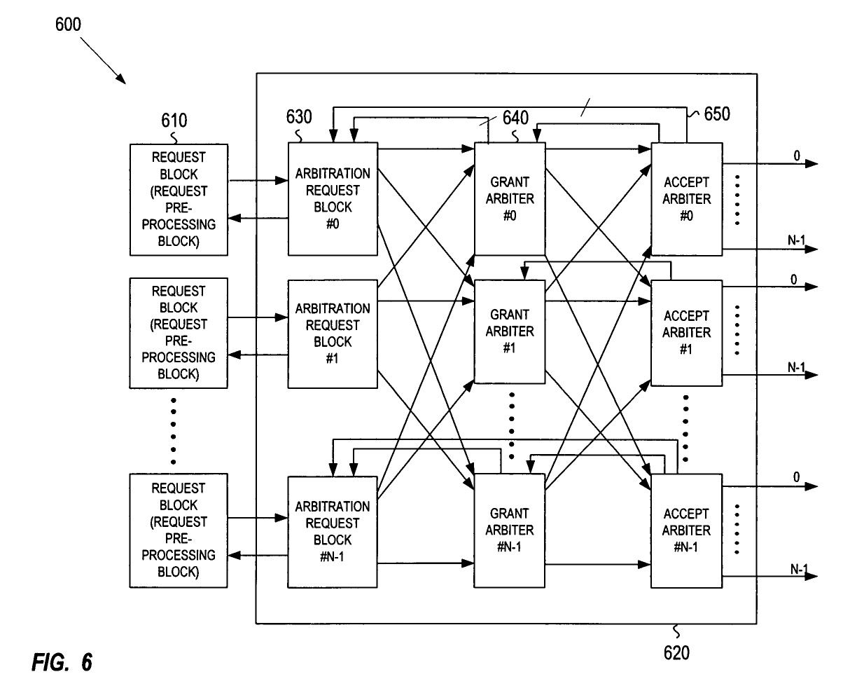

FIG. 6 illustrates an example scheduling engine 600. The scheduling engine 600 includes request pre-processing blocks 610 and an arbitration block 620. The request pre-processing blocks 610 are associated with specific ingress ports. For example, if there are 64 ingress ports there are 64 request pre-processing blocks 610. The request pre-processing block 610 for an ingress port receives the requests for the ingress port (for each egress port and possibly each priority). For example, if there are 64 egress ports and 4 priorities, there are 256 individual requests contained in a request frame received from the ingress port.

As each request may define external criteria (e.g., aging, fullness) the request pre-processing block 610 may map the requests an internal scheduler priority level (SPL) based on the external criteria. The length of the SPL (e.g., number of bits) defines the granularity of the SPL.

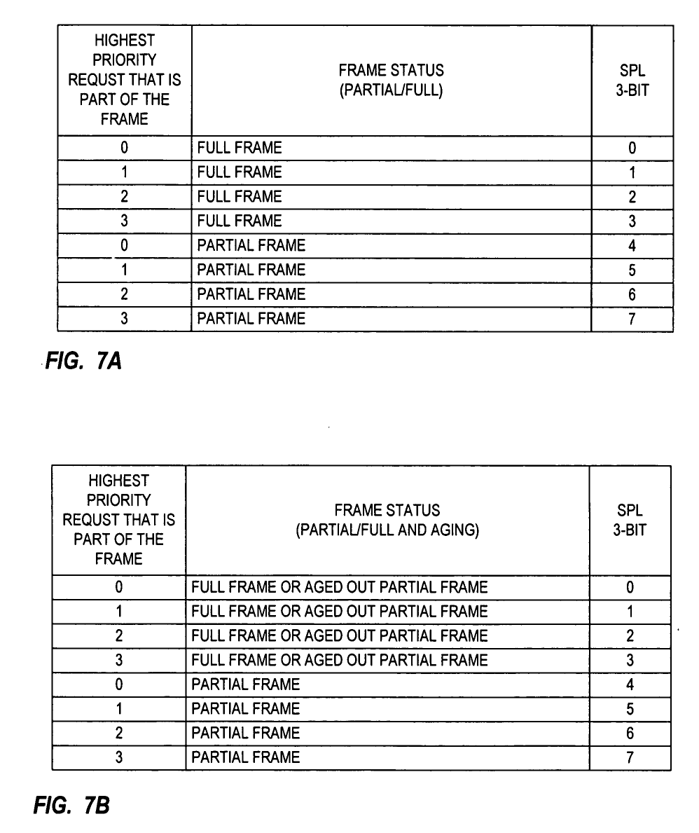

FIG. 7A illustrates an example SPL mapping table for priority and fullness. The SPL is three bits so that 8 SPL levels can be defined. For each priority (4 illustrated), the mapping table differentiates between full frames and partial frames. A frame may be considered full if there are enough segments to aggregate into a frame. The segments may be solely from the particular priority or may include lower priority queues associated with the same destination port. For example, if priority 1 for egress port 7 has ¾ of a frame, and priority 2 has ¼ of a frame, then the priority 1 queue may be considered full.

FIG. 7B illustrates an example SPL mapping table for priority, fullness and aging. As illustrated, a queue only having enough segments for a partial frame is increased in priority if it is aged out. A queue may be aged out if a request has not been granted for a certain number of frame periods.

Referring back to FIG. 6, the arbitration block 620 generates a switching schedule (ingress port to egress port links) based on the requests received from the request pre-processing block 610 and the priority (or SPLs) associated therewith. The arbitration block 620 includes arbitration request blocks 630, grant arbiters 640 and accept arbiters 650. The arbitration request blocks 630 are associated with specific ingress modules. The arbitration request block 630 generates requests (e.g., activates associated bit) for those queues having requests. The arbitration request block 630 sends the requests one priority (or SPL) at a time.

The grant arbiters 640 are associated with specific egress modules. The grant arbiters 640 are coupled to the arbitration request blocks 630 and are capable of receiving requests from any arbitration request block 630. If a grant arbiter 640 receives multiple requests, the grant arbiter 640 will grant one of the requests (e.g., activate the associated bit) based on some type of arbitration (e.g., round robin (RR)).

The accept arbiters 650 are associated with specific ingress modules. The accept arbiters 650 are coupled to the grant arbiters 640 and are capable of receiving grants from any grant arbiter 640. If an accept arbiter 650 receives multiple grants, the accept arbiter 650 will accept one of the grants (e.g., activate the associated bit) based on some type of arbitration (e.g., RR). When an accept arbiter 650 accepts a grant, the arbitration request block 630 associated with that ingress port and the grant arbiter 640 associated with that egress port are disabled for the remainder of the scheduling cycle.

Each iteration of the scheduling process consists of the three phases: requests generated, requests granted, and grants accepted. At the end of an iteration the process continues for ingress and egress ports that were not previously associated with an accepted grant.

After an accept arbiter 650 accepts a grant, the scheduler can generate a grant for transmission to the associated ingress port. A grant also may be sent to the associated egress port. The grants to the ingress port and the egress port may be combined in a single grant frame.

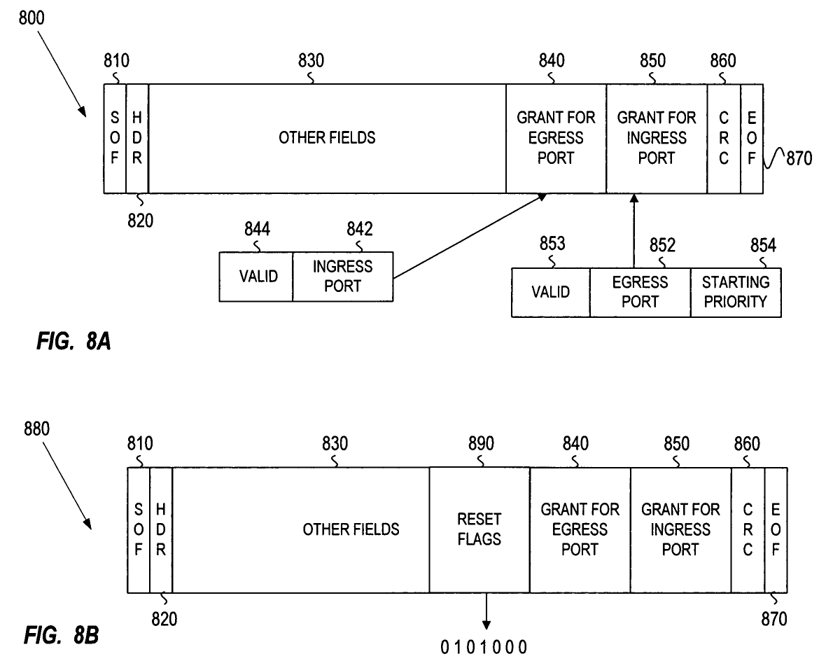

FIG. 8A illustrates an example combined grant frame 800. The grant frame 800 includes a start of frame (SOF) delimiter 810, a frame header 820, other fields 830, an egress module grant 840, an ingress module grant 850, an error detection/correction field 860, and an end of frame (EOF) delimiter 870. The other fields 830 can be used for communicating other information to the ingress and egress modules, such as flow control status.

The egress module grant 840 may include an ingress module (input port) number 842 representing the ingress module it should be receiving data from, and a valid bit 844 to indicate that the field is valid. The ingress module grant 850 may include an egress module (output port) number 852 representing the egress module to which data should be sent, a starting priority level 854 representing the priority level of the queue that should be used at least as a starting point for de-queuing data to form the frame, and a valid bit 856 to indicate that the information is a valid grant. The presence of the starting priority field enables the scheduler to force the ingress module to start de-queuing data from a lower priority queue when a higher-priority queue has data. This allows the system to prevent starvation of lower-priority data.

The flows may be weighted in order to provide bandwidth guarantees (quality of service). The weighting may be defined as a certain amount of data (e.g., bytes, segments, frames) over a certain period (e.g., time, cycles, frame periods). The period may be referred to as a “scheduling round” or simply “round”. When the weighting for a particular flow is satisfied for a particular scheduling round, the flow is disabled for the remainder of the period in order to provide the other flows with the opportunity to meet their weights. The grants issued by the scheduler should be proportional to the programmed weights.

According to one embodiment, the weights associated with the flows may be stored in the scheduler so that the scheduler can determine when a flow has met its weight. The scheduler may track the amount of data sent based on the grants issued. Alternatively, the ingress port may track the amount of data dequeued for the flows associated therewith and provide that data to the scheduler. The scheduler may compare the data transmitted to the weighting to determine when the weighting has been satisfied.

According to one embodiment, the weights for the flows may be stored in the respective ingress ports. The ingress ports may keep a running total of the amount of data transmitted per flow during a period. The ingress port may compare the running total to the weight and determine the weighting is satisfied when the running total equals or exceeds the weight. The ingress port may maintain a satisfied bit for each flow and may activate the bit when the weight is satisfied. The ingress port informs the scheduler when a particular flow has been satisfied. The ingress port may include the satisfaction notification in a request (next request sent). The request frame may include weight satisfied flags (e.g., bit) for each of the flows and the flags associated with satisfied flows may be activated.

FIG. 4B illustrates an example request frame 480 that includes satisfied flags 490. The satisfied flags 490 may be a bit map having a bit for each of the flows handled by the ingress port. As illustrated, there are 8 flows associated with the ingress port and the second and fourth flows are satisfied (bits set to 1).

The scheduler receives the satisfied information from the ingress port and deactivates the associated flow from consideration for the remainder of the current scheduling round in the arbitration of requests. The scheduler may maintain a satisfied bit for each flow and may activate the bits when informed that the flow is satisfied by the ingress port. When the satisfied bit is active the flow is deactivated. The flow may be deactivated by preventing the associated arbitration block from sending a request to the associated grant arbiter within the scheduler.

The scheduler maintains data related to the duration of the scheduling round with which the weights are associated. The scheduler tracks the duration of the current scheduling round and when the duration is up, instructs the ingress ports to restart the running counts. The scheduler may also reset the count for particular flows during the scheduling round. For example, if there are no other requests from the ingress port, for the egress port, or for the priority (or SPL) associated with the satisfied flow. The flow may also be reset during the period if there are requests from the ingress port, for the egress port and/or the priority (or SPL), but a grant has not been accepted for more than a programmable number of consecutive frame times implying that the ingress port is giving priority to other flows. The scheduler may send the reset instructions in grants.

The scheduler may maintain a reset bit for each flow and the bit may be set when the running totals for the flow should be reset. The grant frames may include reset flags (e.g., bits) for each of the flows associated with an ingress port and the flags associated with the flows that should be reset may be activated.

FIG. 8B illustrates an example grant frame 880 that includes reset flags 890. The reset flags 890 may be a bit map having a bit for each of the flows handled by the ingress port. As illustrated, there are 8 flows associated with the ingress port and the second and fourth flows are flagged to be reset (bits set to 1).

The scheduler may reset a set reset bit and a corresponding set satisfied bit the next frame period after the grant frame with the reset flag activated is forwarded to the ingress port. Due to the pipelined nature of the switching device the scheduler may receive request frames with satisfied flags set for particular flows after the scheduler has sent a grant frame with a reset flag set for the particular flow. Since the scheduler will be working on the most recent data, if the scheduler receives a request frame with a satisfied flag set for a particular flow in the same frame period as the scheduler is resetting the reset bit and the satisfied bit maintained in the scheduler for the particular flow the satisfied flag in the request will be ignored.

When the ingress ports receive the reset information they may reset the running totals for the associated flows. The ingress port may maintain a reset bit for each flow and may activate the bit when the reset information is received from the scheduler. When the reset bit is activated for a flow the running count may be cleared in the next frame period and after the running count is cleared the reset bit may be deactivated in the next frame time.

The reset bit map may be sent by the scheduler to the ingress port every frame period. The ingress port may update its reset bit map based thereon. However, since the reset bits may be deactivated in the scheduler before the ingress port has reset its running counts for the associated flows, the reset bit map received from the scheduler may be logically ORed with the current reset bit map to ensure the resets are not deactivated before the counts have been

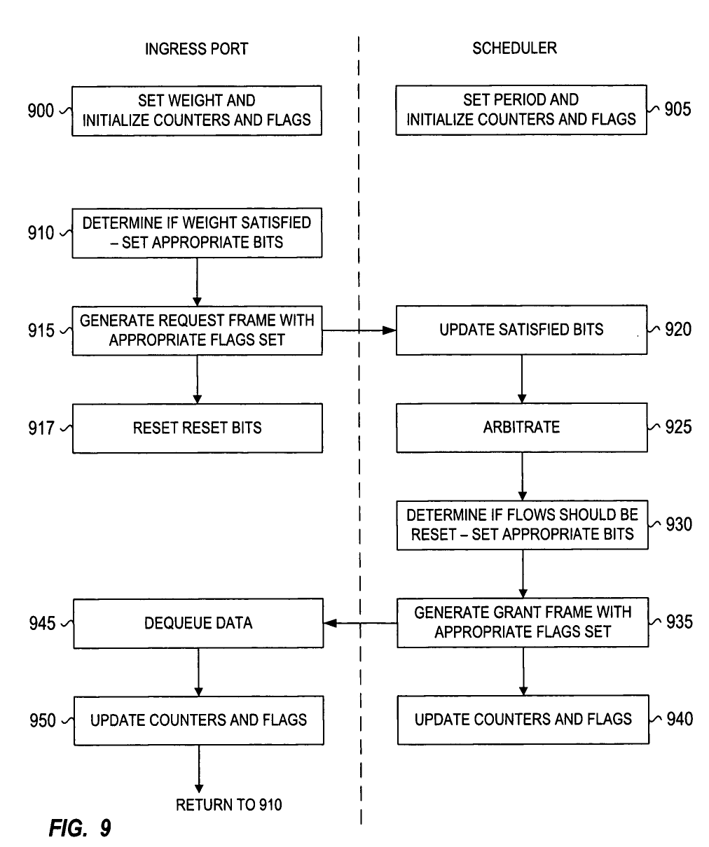

FIG. 9 illustrates an example flow chart for scheduling of weighted flows. Based on the desired class of service for the various flows associated with the switching device the length of the round and the weights for flows are assigned. The weights are stored in the respective ingress ports (900). That is, each ingress port maintains the weights of those flows originating at the ingress port. The ingress port also maintains a running count of the amount of data transmitted for each of the flows originating from it, a satisfied bit to indicate when the amount of data meets or exceeds the weight, and a reset bit to indicate when the count and the satisfied bits should be reset for the flows associated with the ingress port. Initially, the running count for the flows will be 0 and the satisfied and reset bits will be deactivated.

The length of the scheduling round is stored in the scheduler (905). The scheduler will also maintain a running count of the frame periods to track the progress of the scheduling round, a reset bit for each flow to indicate when the flow should be reset, and a satisfied bit for each flow to indicate when the weight for the flow is satisfied and should be excluded from scheduling. Initially, the running count for the frame periods will be 0 and the satisfied and reset bits will be deactivated.

The flow chart of FIG. 9 will discus the actions of a single ingress port for ease of explanation but these actions will be taken by each ingress port. The ingress port will read a running count and weight for each of the flows and determine if the weight has been satisfied (910). If the weight is satisfied the satisfied bit for the flow will be activated in the ingress port. The ingress port generates a request frame during every frame period that includes requests and satisfied flags for the flows handled by the ingress port (915). The satisfied flags are set if the satisfied bit in the ingress port is set indicating the weight for the flow has been satisfied. If the counts and satisfied flags were reset for a flow due to a reset bit being set for the flow, the reset bit is reset the next frame period after the counts and satisfied flag are updated (917).

The scheduler receives the requests and updates the satisfied bits maintained therein based on the satisfied flags in the request frame (920). The scheduler deactivates any flow having a satisfied bit set for the remainder of the current scheduling round, and arbitrates amongst the remaining requests received from each of the ingress ports (925). The scheduler updates the running frame period total and determines if any or all of the flows should be reset (930). The reset determination includes determining if the running total of the frame periods equals the duration of the scheduling round stored therein. The determination also includes determining if no requests are being received for other ingress ports, egress ports, or priorities associated with a satisfied flow or if requests are being received but not granted. The reset bits for the appropriate flows are set. The scheduler generates a grant frame every frame period for each of the ingress ports that includes grants and reset flags for the associated flows (935). The reset flags are set if the reset bit in the scheduler is set indicating the flow should be reset.

After the grant frame is sent, the scheduler updates the counters and flags (940). If no reset flags were set in the grant frame that was sent the previous frame period than no updates are required. If the reset flag was set for all the flows indicating that the round ended, the count is reset as are the reset and satisfied flags for all of the flows. If the reset bit was only set for a subset of the flows, the reset and satisfied bits are reset for the subset of flows.

The ingress port receives the grant and dequeues data from the associated queues and transmits the data to the appropriate egress port via the switch fabric (945). As the data is being dequeued the ingress port updates the counts and flags for the associated flows (950). The running total is increased by the amount of data that is dequeued. The reset bits for the flows are updated based on the grant frame received. As previously mentioned the reset bit map in the ingress port may be logically ORed with the reset bitmap received in the grant frame. If the reset bit is set in the ingress port for a flow the satisfied bit and the running count for the flow are reset.

Resetting the count may not mean setting the count to zero. If the running count was greater than the weight the overage may be counted against the weight in the next round. A difference between the running count and the weight is determined. If the difference is greater than or equal to 0 that means that weight was not exceeded and the running count is simply set to 0. If the count is greater that 0 there was an overage and the running count is set to the overage. If the overage is greater than the weight indicating that more than twice the weight was dequeued last round the count may be set to the weight. After the counts and flags are updated a determination is made as to whether the weights are satisfied and the appropriate satisfied bits are set (910).

The elements of the flowchart may be mapped to the different stages of the store-and-forward pipeline schedule. For example, the request 915 may be the request stage (stage I). The reset 917, update 920, arbitrate 925, determine 930, and generate 935 may be the schedule stage (stage II). The reset 940 and dequeue 945 may be the cross bar configuration stage (stage III). The update 950 and determine 910 may be the data transmission stage (stage IV).

It should be noted that the steps identified in the flowchart may be rearranged, combined and or separated without departing from the scope. Moreover, the pipeline stage within which the specific steps are accomplished may be modified without departing from the scope.

It should also be noted that the disclosure focused on frame based store-and-forward devices but is in no way intended to be limited thereby.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. For example, some implementations feature computer program products disposed on computer readable mediums. The programs include instructions to cause processors to perform the techniques described above.

The various embodiments are intended to be protected broadly within the spirit and scope of the appended claims.

What is claimed is:

1. An apparatus comprising
a plurality of ingress modules to receive packets from external sources and to store the packets in queues based on flow;
a plurality of egress modules to transmit packets received from the plurality of ingress modules to external sources;
a crossbar matrix to provide configurable connectivity between the plurality of ingress modules and the plurality of egress modules; and
a scheduler to receive requests for utilization of the crossbar matrix from at least a subset of the plurality of ingress modules, to arbitrate amongst the requests, and to grant at least a subset of the requests and configure the crossbar matrix based on the granted requests, wherein the flows are assigned weights defining an amount of data to be transmitted during a period, and wherein when a flow meets or exceeds the assigned weight during the period the flow is deactivated from the schedule arbitration.

2. The apparatus of claim 1, wherein the ingress modules maintain the weights and a running count of data transmitted for their associated flows during a period and informs the scheduler when the weight for a flow is satisfied.

3. The apparatus of claim 2, wherein the ingress modules inform the scheduler in a next request.

4. The apparatus of claim 2, wherein the ingress modules maintain a satisfied flag for associated flows and set the flag for a flow when the weight for the flow is met or exceeded.

5. The apparatus of claim 4, wherein a request from an ingress module is for the associated flows and includes the satisfied flag for the associated flows.

6. The apparatus of claim 2, wherein the scheduler resets the running counts maintained by the ingress modules at the end of the period.

7. The apparatus of claim 2, wherein the scheduler can reset the running counts for a particular flow within the period.

8. The apparatus of claim 2, wherein the scheduler maintains a reset bit for the flows and activates the bit for a flow when the running counts for the flow should be reset.

9. The apparatus of claim 8, wherein a grant for an ingress module is for the associated flows and includes the reset flag for the associated flows.

10. The apparatus of claim 1, wherein if the weight for a particular flow is exceeded in a first period the excess is counted toward the weight in a second period.

11. The apparatus of claim 1, wherein the requests include parameters in addition to destination, and wherein the scheduler assigns an internal priority based on these parameters.

12. The apparatus of claim 1, wherein the ingress modules segregate received packets into segments of a first defined size and aggregate the segments into frames of a second defined size for transmission to the egress modules, and wherein the egress modules segregate the frames into segments and aggregate the segments into the packets.

13. A method comprising
receiving packets from external sources at a plurality of ingress modules;
storing the packets in queues based on flow;
sending, to a scheduler, requests for utilization of a crossbar matrix to transmit data to a plurality of egress modules;
arbitrating amongst the requests,
granting at least a subset of the requests;
configuring a crossbar matrix based on the granted requests;
maintaining weights defining an amount of data to be transmitted during a period to the flows;
tracking the amount of data transmitted for each flow during the period;
determining when a flow meets or exceeds the assigned weight during the period; and
deactivating the flow with the exceeded weight from the arbitrating.

14. The method of claim 13, wherein the ingress modules maintain, track and determine and the scheduler deactivates and further comprising informing the scheduler when the flow meets or exceeds the assigned weight.

15. The method of claim 13, further comprising determining when the tracking should be reset and resetting the tracking.

16. The method of claim 15, wherein the scheduler determines and the ingress modules reset, and further comprising informing the ingress modules to reset the tracking.

17. A store and forward device, comprising:
a plurality of interface cards, wherein the interface cards include
a plurality of ingress modules to receive packets from external sources and to store the packets in queues based on flow;
a plurality of egress modules to transmit packets received from the plurality of ingress modules to external sources;
a crossbar matrix to provide configurable connectivity between the ingress modules and the egress modules;
a scheduler to receive requests for utilization of the crossbar matrix from at least a subset of the plurality of ingress modules, to arbitrate amongst the requests, and to grant at least a subset of the requests and configure the crossbar matrix based on the granted requests, wherein the flows are assigned weights defining an amount of data to be transmitted during a period, and wherein when a flow meets or exceeds the assigned weight during the period the flow is deactivated from the schedule arbitration;
a backplane to connect the ingress modules and the egress modules to the crossbar matrix and the scheduler, and the scheduler to the crossbar matrix; and
a rack to house the interface cards, the crossbar matrix, the backplane and the scheduler.

18. The device of claim 17, wherein the ingress modules maintain the weights and a running count of data transmitted for their associated flows during a period and informs the scheduler when the weight for a flow is satisfied.

19. The device of claim 17, wherein the scheduler determines when the running counts should be reset and informs the ingress modules, and the ingress modules reset the running counts.

20. The device of claim 17, wherein the ingress modules segregate received packets into segments of a first defined size and aggregate the segments into frames of a second defined size for transmission to the egress modules, and wherein the egress modules segregate the frames into segments and aggregate the segments into the packets.
